(19) United States
(12) Patent Application Publication
(10) Pub. No.: US 2014/0368162 A1
(43) Pub. Date: Dec. 18, 2014

(54) Touch field compound field detector I.D. cell phone

(71) Applicant: John William Stein, Allentown, PA (US)

(72) Inventor: John William Stein, Allentown, PA (US)

(21) Appl. No.: 13/986,947

(22) Filed: Jun. 18, 2013

(51) Int. Cl. H02J 7/02

(52) U.S. Cl. CPC H02J 7/025
USPC 320/108

(57) ABSTRACT

Finding power to operate electronics on or near a cell phone usually requires a wired power connection making it difficult to add useful and desired electronics to the cell phone. Harvesting power from the cell phone's transmission using this herein described invention eliminates wiring opening up markets for these optional types of cell phone gadgets. The result would expand a cell phone's functionality independent of the cell phone manufacturer. One such device that allows access to doors, computer, autos, etc. whereby just through touch allows access to these things even if the cell phone is left in one's pocket.

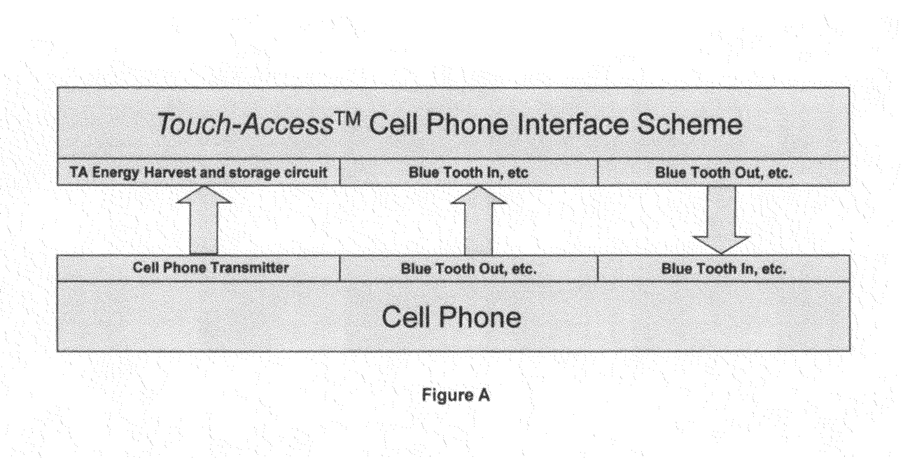

This claims the benefit of a prior filed provisional application #61/690/043 filed on Jun. 18, 2012.

### FIELD OF INVENTION

This application generally relates to cell phones and methods by which power can be harvested from the cell phone's rf transmission energy during the normal operation of the phone to power electronic devices near or attached to the phone.

### BACKGROUND

U.S. Pat. No. 7,890,044 B1 describes a communication method whereby the body of an animal or person can be used as a short range field detector to activate say a tag or fob like device when the body comes in contact with a oscillating voltage. This technology, however, generally requires battery power to operate. To use this field access technology with cell phones would generally require embedding the technology into the phone electronics to allow access to the phone's battery. Unfortunately, if the cell phone's battery were to become exhausted the field detector would cease to operate. This field detector technology is used to gain secure keyless access to doors, computers, office equipment, etc. This situation renders the cell phone a poor choice into which to embed this access technology. Further, using the cell phone as a host for this field detector electronics would require the cell phone manufacturer to integrate this electronics into their phone, possibly as an option, adding cost to the phone.

### BRIEF DESCRIPTION OF THE DRAWINGS

Figure A shows a cell phone in close proximity to the herein described inventive interface scheme electronics which would house the field detector technology describe in U.S. Pat. No. 7,890,044 B1 and other ancillary electronics. Shown is the cell phone transmitter affecting the TA Harvest Circuit. Also shown is an example of ancillary equipment.

### DETAILED DESCRIPTION OF THE EMBODIMENT

Figure A shows the cell phone transmitter passing transmission energy to the TA Energy Harvest Circuit in the embodiment and as a result converting this radio frequency energy into electricity for use by the field detection electronics as well as the ancillary electronics in the embodiment. The generated electricity would generally be stored for later use in batteries, super capacitors, etc. This cell phone harvesting invention should work due to the low power electronics circuits prevalent today and the fact that cell phones are constantly pinging to listen for calls and, of course, put out radio energy during normal cell phone communications. Radio frequency energy harvesting is well known to the art and is to be considered as such.

I claim:

1. an energy harvesting scheme using cell phone transmission rf energy to capture convert and store this energy to produce electricity for use in which to power electronic circuits on or near cell phones.
